(19) United States
(12) Patent Application Publication
(10) Pub. No.: US 2007/0151457 A1
(43) Pub. Date: Jul. 5, 2007

(54) On demand hot liquid dispenser

(76) Inventors: Michelle Rabin, Hood River, OR (US); Sandy M. Bushberg, Hood River, OR (US)

Correspondence Address: Teas & Tonics, 2230 Old Dalles Dr, Hood River, OR, 97031, US

(21) Appl. No.: 11/648,255

(22) Filed: Dec. 29, 2006

Related U.S. Application Data
(60) Provisional application No. 60/755,535, filed on Dec. 30, 2005.

(51) Int. Cl. B67D 1/00

(52) U.S. Cl. 99/275

(57) ABSTRACT

A system for quickly and accurately heating a liquid to a specified temperature and dispensing the liquid on demand. The system is particularly suited for brewing tea and preferably stores preset temperatures corresponding to different tea varieties. Also preferably, the system allows the user to set customized temperatures. The system also comprises a timer, also having preset and user customizable periods adapted for brewing different varieties of tea.

### RELATED APPLICATIONS

This application claims priority to U.S. Provisional Patent Application Ser. No. 60/755,535, filed Dec. 30, 2005. That application is hereby incorporated by reference in its entirety.

### FIELD OF THE PRESENT INVENTION

The present invention relates generally to devices for dispensing a hot liquid on demand. More particularly, the invention relates to a dispenser that delivers hot water at a multitude of specific temperatures to optimize tea brewing.

### BACKGROUND OF THE INVENTION

Tea has been a popular beverage for thousands of years and is indeed second only to water in worldwide consumption. Regardless of the type, white, black, green, or oolong, all teas come from a single plant. The tea leaf comes from Camellia sinensis, a shrub like evergreen plant grown in tropical climates that provide a suitable combination of hot and cool temperatures and heavy rainfall.

Like fine wines or single-malt scotches, the quality, flavor, and aroma of tea is heavily influenced by its surroundings and how it is brewed. Tea offers the discriminating palate subtleties of flavor and aroma and nuances of body and character. Soil, climate, temperature, rainfall, and altitude all contribute to the unique characteristics of each plant and leaf. This variety is reflected in the increasing numbers of specialty teas that are now commonly available to consumers.

In addition to the enjoyment of drinking tea, scientific findings linking tea consumption to improved health have helped fuel a surge in popularity. Tea is now understood to be rich in antioxidants that help protect against aging, cell damage, and diseases such as certain cancers, heart problems, and stroke. The consumption of three or four cups of tea a day can provide 20 to 30 times the antioxidant potency of vitamins C and E. These findings reinforce the traditional understanding that tea provides health benefits, and it has always been prized for its ability to banish fatigue, soothe frayed nerves, stimulate mental powers, and raise the energy level.

With growing popularity has come a growing sophistication and demand for different varieties of teas. However, different varieties of tea require significantly different brewing temperatures. Tea connoisseurs have long understood that proper brewing requires careful attention to the steeping temperature. Generally, the more delicate teas require lower temperatures and the more robust varieties benefit from higher temperatures.

Unfortunately, no devices are currently available that are adapted to quickly and reliably bring water to exact correct temperatures in a manner optimized for brewing tea. Indeed, the most reliable means for generating hot water for brewing tea involves heating water in a kettle over a stove while monitoring the temperature with a thermometer. This process is neither convenient nor timely.

Furthermore, it is not desirable to overheat the water and allow it to cool to the proper steeping temperature. Heating the water unnecessarily, and especially boiling it, causes the water to degas and this will cause tea brewed with such water to taste “flat.” A similar process occurs when water is maintained at elevated temperatures for a significant period of time.

In short, proper brewing of specialty teas requires that cold or room temperature water be brought as quickly as possible up to, but not over, the temperature specific to the variety of tea being consumed.

In other contexts, a variety of appliances have been introduced for the production of hot water but none satisfy the criteria for brewing specialty teas. For example, many home kitchens are equipped with a hot water dispenser that is designed to provide water on demand that is hotter than commonly available from a conventional hot water heater. For example, U.S. Pat. No. 3,381,110 discloses a hot water dispenser that utilizes a smaller reservoir that is kept at elevated temperatures. This device and others like it are permanently plumbed into the house and are configured to deliver water that is as close to boiling as possible. Indeed, the general thrust of such instant hot water devices is to provide water that has a temperature as close to boiling as possible. For the reasons discussed above, these devices are not suitable for brewing specialty teas.

Although conventional coffee makers typically heat the water immediately prior to brewing, these devices provide no capability to delivery water at specific, varying temperatures. Indeed, these coffee makers typically heat the water to boiling temperatures. For example, coffee makers utilizing the designs similar to that disclosed in U.S. Pat. No. 4,558,204 use the production of steam as a means for transporting the heated water to the coffee grounds. Even devices ostensibly designed for brewing tea suffer from these limitations. For example, U.S. Pat. No. 4,266,471 is specifically directed to brewing tea yet it still brings the water to boiling and delivers the water to the tea leaves at that temperature.

Some instant hot water device designs utilize a temperature sensor to control the temperature of the water delivered. For example, U.S. Pat. No. 5,678,734 discloses the use of a temperature sensor to maintain the temperature of water held in a reservoir at a predetermined temperature. Thus, such a design does not provide the capability to supply water at a plurality of specific temperatures. Further, this reference, like the others, is focussed on delivering water only at near boiling temperatures, most preferably greater than 90° C.

Another prior art device known under the trade name “Zarafina”™ is designed to automate the process of brewing tea, rather than providing the user with total control over the brewing process. Specifically, the Zarafina device brings water to different temperatures depending upon the tea being brewed, but also automates the steeping process. The device introduces the tea leaves to the heated water, steeps them for various times depending upon whether the user specifies mild, medium or strong tea, and then dispenses the brewed tea into serving container. The user is not given the option to precisely control the steeping time, but rather must employ the times preprogrammed into the device. Further, the device is not able to provide water of a specified temperature on demand. Instead, the Zarafina device heats the entire, predetermined quantity of water to a preprogrammed temperature selected only by the user's indication of the type of tea being brewed. Thus, the device can not provide water on demand at a precise temperature specified by the user that is ready for brewing tea.

Thus, none of the prior art devices adapted to provide hot water on demand are configured to brew specialty teas. None of the conventional devices have the ability to quickly bring cold water to multiple, user selected specific temperatures without overheating or storing water at an elevated temperature.

Accordingly, it is an object of the present invention to provide an on demand hot water device that supplies water at a plurality of specific temperatures.

It is also an object of the present invention to provide a fully-customizable, multi-temperature, digitally-controlled, instant hot water device.

### SUMMARY OF THE INVENTION

In accordance with the above objects and those that will be mentioned and will become apparent below, the present invention is a system for heating a liquid to a specified temperature and dispensing the liquid, wherein the system comprises a reservoir for holding the liquid, a heater having an inlet and outlet, a pump for delivering the liquid from the reservoir through the heater, a temperature sensor disposed adjacent the heater outlet, a conduit for dispensing liquid from the heater outlet and a controller connected to the temperature sensor, the heater and the pump, wherein the controller operates the heater to heat the liquid to the specified temperature and operates the pump to dispense the liquid. In one embodiment, the controller heats the liquid by operating the heater at varying power levels. In another embodiment, the controller heats the liquid by varying the rate of delivery of the liquid by the pump. In yet another embodiment, the controller heats the liquid by operating the heater at varying power levels and by varying the rate of delivery of the liquid by the pump.

In preferred embodiments, the controller is configured to operate the heater so that the liquid is heated to one of a plurality of predetermined temperatures. In one embodiment, the controller is configured to heat the liquid to four predetermined temperatures. Preferably, the first temperature is in the range of approximately 71.11 to 76.67° C., the second temperature is in the range of approximately 71.11 to 82.22° C., the third temperature is in the range of approximately 76.67 to 87.78° C., and the fourth temperature is in the range of approximately 87.78 to 97.78° C. In another embodiment, the first temperature is adapted for brewing white tea, the second temperature is adapted from brewing oolong tea, the third temperature is adapted for brewing green tea and the fourth temperature is adapted for brewing black tea, blends and herbal tisanes.

In yet another embodiment, the controller is configured to heat the liquid to a precise temperature determined by the user.

In one embodiment of the invention, the system is configured to heat approximately 250 ml of liquid from room temperature to the specified temperature above approximately 70° C. within approximately 1 min. Preferably, the system heats the liquid within approximately 30 sec.

In another embodiment of the invention, the system is configured to begin dispensing liquid heated to the specified temperature within 30 sec. of activation. Preferably, the system dispenses heated liquid within 10 sec. of activation.

In one embodiment of the invention, the system dispenses liquid that is within approximately 2° C. of the specified temperature. Preferably, the liquid is within approximately 1° C. of the specified temperature.

In a further embodiment of the invention, the system further comprises a timer that is activated when the heated liquid is dispensed. Preferably, the timer is configured to measure a brewing time suited to the type of tea being prepared. In some embodiments, the brewing time corresponds to the selected temperature. In one embodiment of the invention wherein a predetermined temperature is in the range of approximately 71.11 to 76.67° C., the brewing time is in the range of approximately 30 sec to 3 min. In another embodiment of the invention wherein a predetermined temperature is in the range of approximately 71.11 to 82.22° C., the brewing time is in the range of approximately 2 to 4 min. In another embodiment of the invention wherein a predetermined temperature is in the range of approximately 76.67 to 87.78° C., the brewing time is in the range of approximately 1 to 4 min. In yet another embodiment of the invention wherein a predetermined temperature is in the range of approximately 87.78 to 97.78° C., the brewing time is in the range of approximately 3 to 5 min.

In a further aspect of the invention, the timer of the noted embodiments is configured to measure sequentially longer brewing times to correspond to successive brewings of the same tea leaves.

In one embodiment of the invention, the reservoir is removable. Preferably, the reservoir comprises a sealable port that is configured to mate with an adapter that conveys liquid from the reservoir to the heater inlet.

In one embodiment of the invention, the system comprises a light at the outlet configured to illuminate an area to which the liquid will be dispensed to aid the user in positioning a receptacle to receive the heated liquid.

In another embodiment, the system further comprises a delivery sensor disposed at an outlet of the conduit. Preferably, the delivery sensor is configured to sense the presence of a receptacle adjacent the outlet of the conduit. In the noted embodiment, the delivery sensor is connected to the controller and the controller is configured to operate the pump only when the delivery sensor indicates the presence of the receptacle. Alternatively, the delivery sensor is configured to sense an operator touching the system near the conduit. In one embodiment, the delivery sensor is a capacitance sensor. In the noted embodiment, the delivery sensor is connected to the controller and the controller is configured to disable the pump when the delivery sensor indicates that the operator is touching the system near the conduit.

In one embodiment of the invention, the system comprises program buttons corresponding to each predetermined temperature, whereby the controller heats the liquid to the predetermined temperature and dispenses the heated liquid.

In one embodiment of the invention, the system comprises a dispenser button wherein the controller is configured to deliver liquid heated to the specified temperature when the dispenser button is depressed and to terminate delivery of the heated liquid when the push button is depressed again. In an alternate embodiment of the invention, the controller is configured to deliver a predetermined amount of heated liquid when the push button is depressed. Preferably, the controller will deliver the predetermined amount of liquid and stop automatically unless the push button is depressed to terminate delivery before the predetermined amount is delivered.

In another embodiment of the invention, the controller is configured to allow a user to select a customized temperature, preferably by using additional program buttons. In a further aspect, the period of time measured by the timer is user adjustable, preferably by using the program buttons.

In another embodiment of the invention, the system comprises a digital display, preferably configured to indicate information including, but without limitation, the specified temperature, the variety of tea selected and time remaining in a brewing period.

In a further embodiment, the system also comprises an internal filtration system to filter impurities from the liquid prior to heating.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is a side view of an on demand hot liquid dispenser system of the invention;

FIG. 2 is an isometric view of an on demand hot liquid dispenser system of the invention;

FIG. 3 is a top view of an on demand hot liquid dispenser system of the invention;

FIG. 4 is a rear view of an on demand hot liquid dispenser system of the invention;

FIG. 5 is a schematic diagram of functional components of an on demand hot liquid dispenser system of the invention; and

FIG. 6 is a schematic view of the controller circuitry of an on demand hot liquid dispenser system of the invention.

### DETAILED DESCRIPTION OF THE INVENTION

Before describing the present invention in detail, it is to be understood that this invention is not limited to particularly exemplified materials, methods or structures as such may, of course, vary. Thus, although a number of materials and methods similar or equivalent to those described herein can be used in the practice of the present invention, the preferred materials and methods are described herein.

It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Further, all publications, patents and patent applications cited herein, whether supra or infra, are hereby incorporated by reference in their entirety.

Finally, as used in this specification and the appended claims, the singular forms “a, “an” and “the” include plural referents unless the content clearly dictates otherwise.

In accordance with the above objects and those that will be mentioned and will become apparent below, the present invention is a system for quickly heating a liquid to a specified temperature and dispensing the liquid on demand. Preferably, the system heats the liquid to one of a plurality of predetermined temperatures.

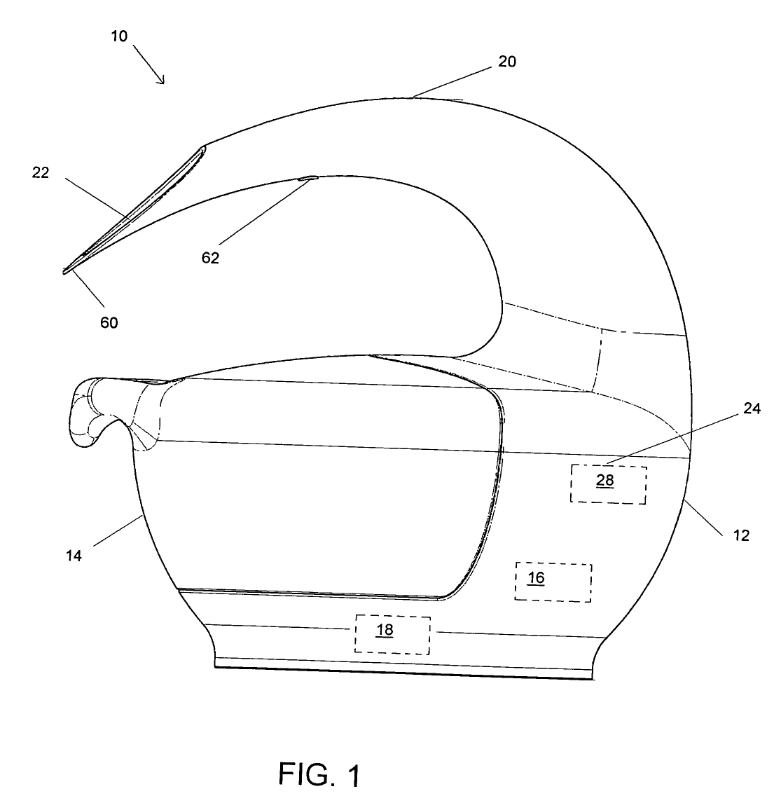

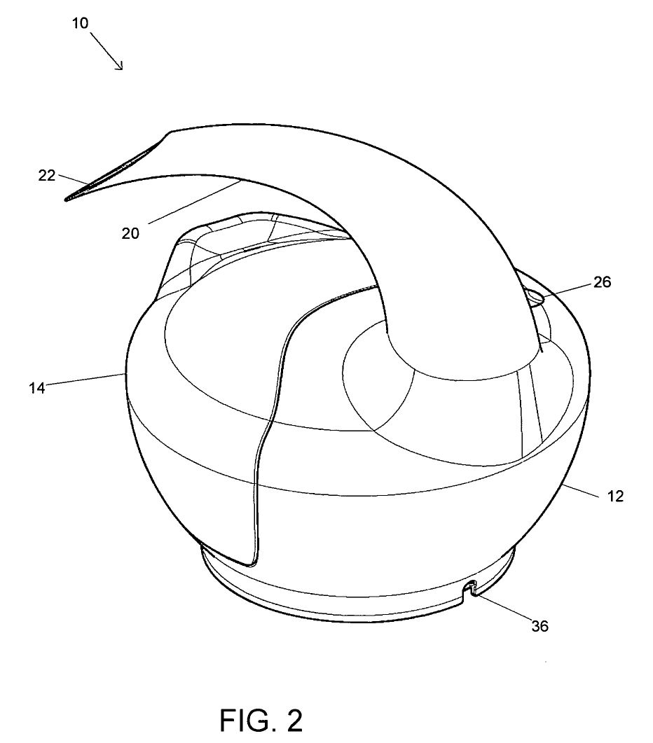

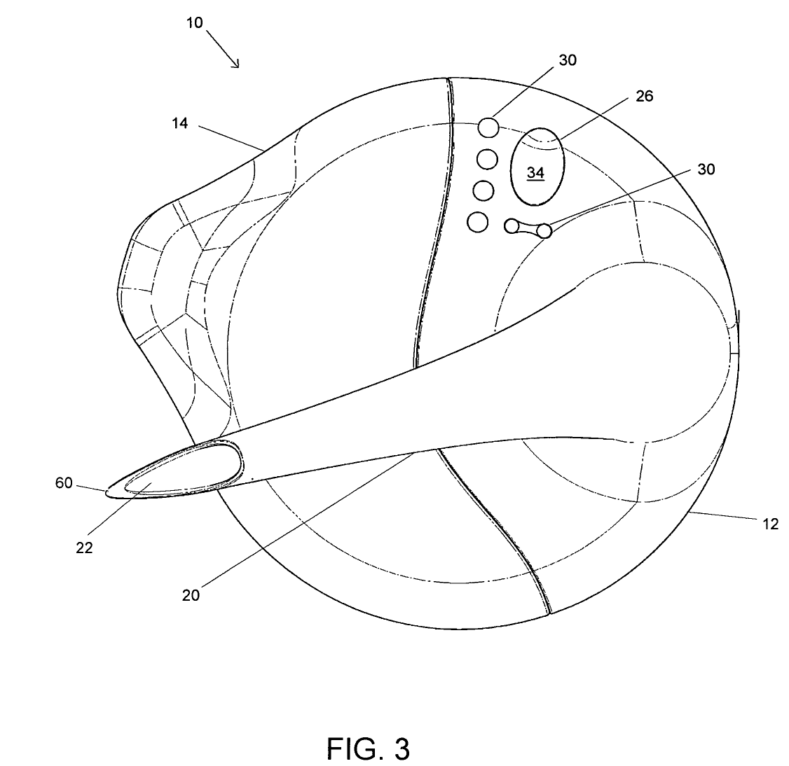

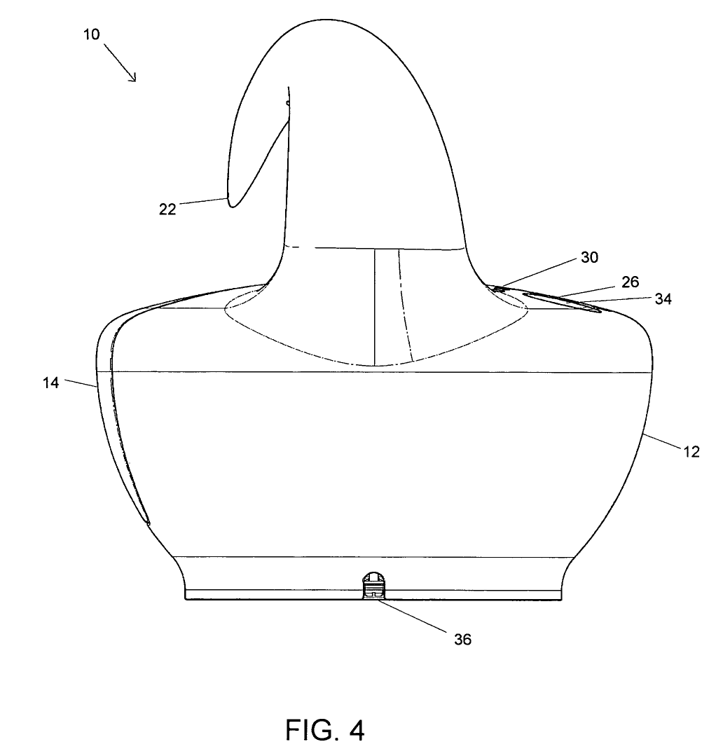

FIGS. 1-4 show the system 10 in a variety of views, including FIG. 1 which is a side view, FIG. 2 which is an isometric view, FIG. 3 which is a top view and FIG. 4 which is a rear view. As illustrated, the system 10 generally includes a main housing 12 adapted to receive a removable reservoir 14 for holding the liquid. Reservoir 14 communicates with pump 16 (shown schematically), which is configured to pressurize the liquid sufficiently to transport the liquid through heater 18 (shown schematically) and conduit 20 to dispense the heated liquid through orifice 22. A temperature sensor 24 (shown schematically) is positioned downstream of heater 18. A dispenser button 26 regulates the delivery of heated liquid. A controller 28 (shown schematically) is connected to pump 16, heater 18, and temperature sensor 24. Controller 28 also receives input from temperature buttons 30 and control buttons 32 and displays operating information through display 34, which in the shown embodiment comprises the surface of dispenser button 26. Power for all electronic components is supplied via AC line cord at plug receptacle 36.

Controller 28 operates heater 18 to heat the liquid to the specified temperature and operates pump 16 to dispense the liquid through conduit 20 and out orifice 22. Preferably, controller 28 heats the liquid by operating heater 18 at varying power levels and by varying the rate of delivery of the liquid by pump 16. In other embodiments, controller 28 can adjust the temperature of the liquid by varying either parameter independently. As one having skill in the art will appreciate, the pump and heater system can be augmented with a steam release line to relieve pressure buildup due to vaporizing liquid and provide smoother liquid delivery.

Controller 28 is configured to operate heater 18 and pump 16 so that the liquid is heated to one of a plurality of predetermined temperatures. Also preferably, controller 28 is configured to allow the user to input a customized temperature. In a further aspect of the invention, controller 28 is configured to allow the user to reprogram the predetermined temperatures.

In a currently preferred embodiment, controller 28 is configured to heat the liquid to four predetermined temperatures. Preferably, the first temperature is in the range of approximately 71.11 to 82.23° C., the second temperature is in the range of approximately 71.11 to 82.23° C., the third temperature is in the range of approximately 82.23 to 97.78° C., and the fourth temperature is in the range of approximately 87.78 to 97.88° C. As one having skill in the art will recognize, the first temperature is adapted for brewing white tea, the second temperature is adapted from brewing green tea, the third temperature is adapted for brewing oolong tea and the fourth temperature is adapted for brewing black tea, blends, chai, herbal teas, botanicals and tisanes and the like. In one embodiment of the invention, the user can input a customized temperature up to approximately 94 to 98° C.

In an alternative embodiment, the first temperature is in the range of approximately 43 to 60° C., the second temperature is in the range of approximately 71 to 80° C., the third temperature is in the range of approximately 88 to 93° C., and the fourth temperature is in the range of approximately 95 to 100° C.

Controller 28 receives input from program buttons 30, and heats the liquid to the corresponding selected temperature and delivers the heated liquid when a dispenser button 26 is depressed. Preferably, controller 28 is configured to deliver a preset quantity of liquid when dispenser button 28 is depressed. In an alternative embodiment, controller 28 is configured to deliver liquid heated to the selected temperature when dispenser button 26 is depressed and to terminate delivery of the heated liquid when dispenser button 26 is depressed again. Alternatively, controller 28 is configured to deliver liquid heated to the selected temperature as long as dispenser button 26 is depressed. In a further aspect of the invention, controller 28 is configured to deliver a predetermined amount of heated liquid with each sequential depression of dispenser button 26. In one embodiment, the predetermined amount of liquid is approximately 230 ml. Preferably, controller 28 will deliver the predetermined amount of liquid and stop automatically unless dispenser button 26 is depressed again to terminate delivery before the predetermined amount is delivered.

Digital display 34 preferably indicates operating information including, but without limitation, the selected predetermined temperature, the variety of tea selected and time remaining in a given brewing period. Preferably, display 34 comprises a seven segment, three digit LCD or LED display. Display 34 can also be configured to display various icons indicating system operation. Display 34 is also preferably configured to display the temperature of the liquid being dispensed. More preferably, the displayed temperature is accurate to within approximately 1° C. As discussed above, display 34 is disposed upon the surface of dispenser button 26. In other embodiments, a separate display is used.

Controller 28 preferably includes a timer that is activated when the heated liquid is dispensed. Alternatively, the timer is activated by the user as desired. Timer information is transmitted to digital display 34. Preferably, the timer is configured to track a brewing time suited to the type of tea being prepared. In some embodiments, the brewing time corresponds to the selected temperature. In one embodiment of the invention wherein a predetermined temperature is in the range of approximately 71.11 to 82.23° C., the brewing time is in the range of approximately 1 min to 3 min. In another embodiment of the invention wherein a predetermined temperature is in the range of approximately 71.11 to 82.23° C., the brewing time is in the range of approximately 30 sec to 3 min. In another embodiment of the invention wherein a predetermined temperature is in the range of approximately 82.23 to 97.78° C., the brewing time is in the range of approximately 1 to 4 min. In yet another embodiment of the invention wherein a predetermined temperature is in the range of approximately 87.78 to 97.88° C., the brewing time is in the range of approximately 3 to 10 min. The brewing time is indicated on display 34.

Preferably, the timer is configured to measure sequentially longer brewing times to correspond to successive brewings of the same tea leaves. Since brewing time is ultimately governed by individual taste, the controller 28 is also preferably configured to allow the user to easily set customized brewing times via program buttons 30, in addition to any preprogrammed brewing times.

Reservoir 14 is preferably formed from a high strength, food grade material such as tempered glass, borosilicate glass, other glasses, stainless steel, enameled metal or polycarbonate plastic, although other polymeric materials can also be used. In the shown embodiment, reservoir 14 is removable, having self-sealing connection that mates with an inlet conduit that delivers liquid from reservoir 14 to heater 18. One example of a suitable self-sealing connection is disclosed in U.S. Pat. No. 5,370,040, which is hereby incorporated by reference in its entirety. In other embodiments of the invention, the reservoir is not removable and is secured to the housing. Preferably, the reservoir has a volume of in the range of approximately 1-2 liters, and more preferably, the reservoir has a volume of approximately 1.5 liters.

Preferably, heater 18 generally comprises a portion of the system where a volume of liquid is adjacent electrical resistance heating elements so that efficient heat transfer can occur. In one embodiment, heater 18 comprises a secondary tank with an immersed 2000 W heating element. In one embodiment, liquid heated to the selected temperature begins flowing within 30 sec. of activation, and preferably within 10 sec., more preferably within 7 sec. and even more preferably within 5 sec. Also preferably, heater 18 is configured to heat approximately 230 ml of the liquid to the selected temperature within approximately 1 min, more preferably, within 30 seconds, and even more preferably, within 15 sec.

In alternative embodiments of the invention, heater 18 comprises an in-line system with coils of tubing that conduct liquid past the heating elements. By adjusting the length of the tubing and the surface area exposed to the heating elements, sufficient heat transfer can be ensured to allow the liquid to reach the selected predetermined temperature. As discussed above, controller 28 can also vary the rate of liquid delivery by pump 16 to provide greater time for the heat transfer to occur. In further embodiments, other heating elements, such as inductive, can be used as desired.

Temperature sensor 24 communicates to controller 28 so that controller can operate heater 18 and pump 16 at power levels necessary to cause the liquid to reach the predetermined temperature. Temperature sensor 24 can comprise a thermocouple, a thermistor, an infra-red temperature sensor or the like. Once stabilized, controller 28 in conjunction with temperature sensor 24 preferably maintains the temperature of the heated liquid within 2° C. of the predetermined temperature, and more preferably within 1° C. In a further embodiment, a secondary temperature sensor is positioned upstream from heater 18 and communicates the temperature of the liquid in reservoir 14 to controller 28 to provide more accurate estimation of the operating conditions necessary to achieve the predetermined temperature.

In an alternative embodiment, particularly with regard to use with an in-line heating system, the initial volume of liquid delivered may not match the predetermined temperature. Accordingly, temperature sensor 24 quickly provides feedback so that controller 28 can operate to achieve the predetermined temperature, preferably within the delivery of approximately 20 ml.

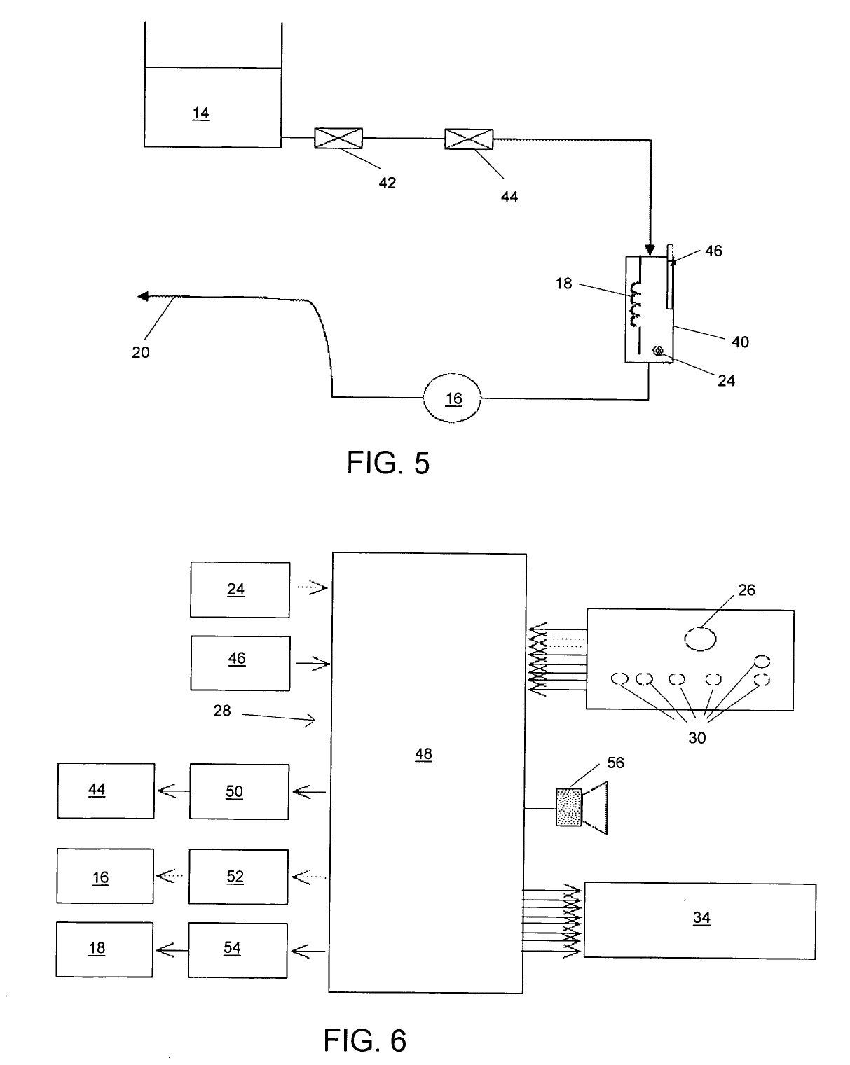

Turning now to FIG. 5, the functional components of system 10 are shown schematically. Reservoir 14 holds a reserve of liquid and is in fluid communication with a secondary tank 40, which preferably is located in housing 12 below reservoir 14 and has a volume corresponding to about one serving, or approximately 250 ml. A check valve 42 provides the self-sealing connection between the removable reservoir 14 and the internal components of the system. A solenoid valve 44 regulates the flow of liquid from reservoir 14 to the inlet of secondary tank 40. A level sensor 46 determines the presence of sufficient liquid for the proper operation of heater 18. As described above temperature sensor 24 is used to monitor the temperature of liquid in the secondary tank 40. Pump 16 delivers the heated liquid from the outlet of secondary tank 40 to the conduit 20.

FIG. 6 schematically illustrates the interaction of controller 28 and various components of system 10. Controller 28 preferably comprises an integrated circuit microcontroller MCU 48 that receives input from sensors, such as temperature sensor 24 and level sensor 46 and input from dispenser button 26 and program buttons 30. MCU 48 sends output to digital display 34 and controls the operation of solenoid valve 44, pump 16 and heater 18 through solid state switches 50, 52 and 54, respectively. Preferably, the solid state switches comprise thryistors, although other components can be substituted as desired. MCU 48 also signals various operating states audibly through speaker 56. If level sensor 46 indicates that there is insufficient liquid in secondary tank 40, MCU 48 will not operate heater 18 or pump 16 and can send a message to display 34. Also preferably, MCU 48 is thermally insulated from heater 18. Other suitable methods of heat dissipation can also be employed, including louvers or vents, preferably on the bottom of housing 12, or water recirculation from reservoir 14, which would also facilitate heating the liquid.

One example of normal operation of an embodiment of the invention comprises the user filling reservoir 14 with liquid and docking it in system 10. A connection is made through check valve 42, allowing the liquid in reservoir 14 to enter the system. MCU 48 switches solenoid valve 44 through thyristor 50 to allow liquid to fill secondary tank 40. When level sensor 46 indicates secondary tank 40 is full, for example, with approximately 250 ml, solenoid valve 44 is closed. Heater 18 is activated to bring the liquid in the secondary tank 40 up to an interim temperature, such as approximately 60° C. The user specifies a desired temperature using program buttons 30 and depresses dispense button 26. MCU 48 operates heater 18 via thyristor 52 to bring the temperature of the liquid up to the specified temperature. As discussed above, the liquid is heated to the specified temperature essentially immediately, preferably within 30 sec., more preferably within 15 sec., and even more preferably within 10 sec. When temperature sensor 24 indicates the selected temperature has been achieved, MCU 48 operates pump 16 via thyristor 54 to deliver the heated liquid to conduit 20, to be dispensed at orifice 22. The volume of liquid in secondary tank 40 is dispensed within 15 sec., and more preferably, within 10 or 5 sec. After liquid is dispensed, MCU 48 can send timer information to display 34 to aid the user in brewing tea or preparing other beverages.

In one embodiment of the invention, program buttons 30 comprise four preset buttons and up and down buttons. Accordingly, the user can quickly select one of four preset temperatures or times. By pressing the up and down buttons, the user can modify the preset values to customize the operation of the system.

In one aspect of the invention, system 10 comprises a light 60 that illuminates a zone adjacent the orifice 22 where the heated liquid will be dispensed. Light 60 comprises an LED, incandescent bulb or any other suitable light source. This gives the user an easy way to properly position a receptacle for the heated liquid and provides a reminder that such a receptacle needs to be in place.

In further aspects of the invention, the system 10 comprises a delivery sensor configured to sense the presence of a receptacle adjacent orifice 22. A suitable delivery sensor generally comprises an infrared transmitter detector pair to determine the proximity of a solid object. Other electromagnetic wavelengths are also suitable. In such embodiments, controller 28 receives input from the delivery sensor and operates pump 16 only when the delivery sensor indicates the presence of the receptacle.

In other embodiments, the delivery sensor is configured to sense an operator presence in the vicinity of the system near conduit 20. Preferably, such delivery sensors comprise a capacitance touch sensor 62 positioned on conduit 20. In such embodiments, controller 28 receives input from the delivery sensor and disables pump 16 when the sensor indicates that an operator is touching the system orifice 22 or in the vicinity.

In another embodiment, a secondary heating element can be employed to preheat the liquid in the reservoir to decrease the time necessary to heat the liquid to the selected temperature.

In yet another embodiment, the system further comprises a secondary electrical energy system to supplement the power available through receptacle 36. For example, the secondary energy system can comprise a capacitor system configured to store electrical energy delivered through the AC line cord as soon as the system is plugged into a wall socket. In such an embodiment, the capacitor system can discharge to power heater 18 in conjunction with the line voltage to decrease the time necessary to the liquid to the selected temperature. As one of skill in the art will recognize, other electrical storage systems can also be employed.

In another embodiment of the invention, a system is configured for use in a conunercial application. For example, a commercial embodiment can employ multiple reservoirs held at the specific temperatures desired to brew the various specialty teas. Further, a commercial embodiment may be plumbed directly to a water supply.

In another embodiment of the invention, the system further includes a filtration component to treat the liquid before heating. In such embodiments, the filtration system can be configured in-line with the water supply or can be an internal component of the system.

In yet another aspect of the invention, the system 10 further comprises a steeping chamber subassembly that receives heated liquid and is configured to combine the liquid with a specific substance, such as tea in whole leaf, bag, powder or other state, coffee, hot chocolate, soup, bullion or other consumable requiring hot liquid. In such embodiments, the chamber would have a related control element such as a timer and valve system to dispense the mixed liquid after a desired amount of time. Further, such embodiments preferably also have an option to dispense heated liquid to the chamber or directly to an external receptacle.

In another embodiment of the invention, controller 28 is configured to have a cleaning function in which high temperature liquid is passed through the system to clean the system at desired intervals.

In yet another embodiment of the invention, the system 10 comprises an auxiliary heating area configured to keep a receptacle for receiving the dispensed heated liquid warm. As one having skill in the art, such a heating area can comprise a heating pad or the like.

In summary, one embodiment of the invention is a system for heating a liquid to a predetermined temperature and dispensing the liquid. Preferably, the system is configured to heat water to one of a plurality of predetermined temperatures to optimize brewing of tea, depending upon the variety of tea being used.

Described herein are presently preferred embodiments, however, one skilled in the art that pertains to the present invention will understand that there are equivalent alternative embodiments. As such, changes and modifications are properly, equitably, and intended to be, within the full range of equivalence of this disclosure.

What is claimed is:

1. A system for heating a liquid to a predetermined temperature and dispensing the liquid, wherein the system comprises a reservoir for holding the liquid, a heater having an inlet and outlet, a pump for delivering the liquid from the reservoir through the heater, a temperature sensor disposed adjacent the heater outlet, a conduit for dispensing liquid from the heater outlet and a controller connected to the temperature sensor, the heater and the pump, wherein the controller operates the heater to heat the liquid to the predetermined temperature and operates the pump to dispense the liquid.

2. The system of claim 1, wherein the controller is configured to operate the heater so that the liquid is heated to one of a plurality of predetermined temperatures.

3. The system of claim 2, wherein the controller is configured to heat the liquid to four predetermined temperatures.

4. The system of claim 3, wherein the four predetermined temperatures comprises a first temperature in the range of approximately 71.11 to 82.23° C., a second temperature in the range of approximately 71.11 to 82.23° C., a third temperature in the range of approximately 82.23 to 97.78° C., and a fourth temperature in the range of approximately 87.78 to 97.88° C.

5. The system of claim 3, wherein the four predetermined temperatures are adapted for brewing tea and wherein the first temperature is adapted for brewing white tea, the second temperature is adapted from brewing oolong tea, the third temperature is adapted for brewing green tea and the fourth temperature is adapted for brewing black tea, blends and herbal tisanes.

6. The system of claim 1, wherein the controller is configured to heat the liquid to a specific temperature determined by the user.

7. The system of claim 1, wherein the system is configured to heat approximately 250 ml of liquid from room temperature to a specified temperature above 70° C. within approximately 1 min.

8. The system of claim 7, wherein the system is configured to heat approximately 250 ml of liquid from room temperature to the specified temperature above 70° C. within approximately 30 sec.

9. The system of claim 1, wherein the system is configured to begin dispensing liquid heated to a specified temperature within 30 sec. of activation.

10. The system of claim 9, wherein the system is configured to begin dispensing liquid heated to the specified temperature within 10 sec. of activation.

11. The system of claim 1, wherein the system dispenses liquid that is within approximately 2° C. of a specified temperature.

12. The system of claim 11, wherein the system dispenses liquid that is within approximately 2° C. of the specified temperature.

13. The system of claim 1, further comprising a timer.

14. The system of claim 2, further comprising a timer wherein the timer has predetermined periods corresponding to the predetermined temperatures.

15. The system of claim 1, wherein the timer is configured to measure sequentially longer periods to correspond to successive brewings of tea leaves.

16. The system of claim 1, wherein the reservoir is removable and wherein the reservoir comprises a sealable port that is configured to mate with an adapter that conveys liquid from the reservoir to the heater inlet.

17. The system of claim 1, wherein the system comprises a light at the outlet configured to illuminate an area to which the liquid will be dispensed to aid the user in positioning a receptacle to receive the heated liquid.

18. A method for heating liquid comprising the steps of:
a. providing an appliance having a reservoir for holding the liquid, a heater having an inlet and outlet, a pump for delivering the liquid from the reservoir through the heater, a temperature sensor disposed adjacent the heater outlet, a conduit for dispensing liquid from the heater outlet and a controller connected to the temperature sensor, the heater and the pump;
b. specifying a temperature, wherein the controller operates the heater to heat the liquid to the specified temperature; and
c. dispensing the heated liquid, wherein the controller operates the pump to deliver the liquid through the conduit.

19. A method for brewing tea, comprising the steps of:
a. providing an appliance having a reservoir for holding room temperature water, a heater having an inlet and outlet, a pump for delivering water from the reservoir through the heater, a temperature sensor disposed adjacent the heater outlet, a conduit for dispensing water from the heater outlet and a controller connected to the temperature sensor, the heater and the pump;
b. specifying a temperature corresponding to the variety of tea being brewed, wherein the controller operates the heater to heat the water to the specified temperature, and
c. dispensing the heated water into a receptacle, wherein the controller operates the pump to deliver the water through the conduit.

20. The method of claim 19, wherein the appliance further comprises a timer and further comprising the step of activating the timer for a period corresponding to the variety of tea being brewed, wherein the controller automatically activates the timer after the water is dispensed.
